(19) United States
(12) Patent Application Publication
(10) Pub. No.: US 2006/0162748 A1
(43) Pub. Date: Jul. 27, 2006

(54) Wafer guide and semiconductor wafer drying apparatus using the same

(76) Inventors: Jong-Jae Lee, Gyeonggi-do (KR); Seung-Kun Lee, Gyeonggi-do (KR); Man-Young Lee, Gyeonggi-do (KR); Jae-Heung Jung, Gyeonggi-do (KR); Yang-Ryul Park, Gyeonggi-do (KR); Kyun-Tak Baek, Seoul (KR); Sung-Kook Choi, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/340,325

(22) Filed: Jan. 25, 2006

(30) Foreign Application Priority Data
Jan. 25, 2005 (KR) 2005-06868

(51) Int. Cl. B08B 3/00; A47G 19/08

(52) U.S. Cl. 134/95.2; 134/133; 134/165; 134/902; 211/41.18

(57) ABSTRACT

A wafer guide and a semiconductor wafer drying apparatus using the same are disclosed. The wafer guide includes a body and supporters formed on the body. The supporters present a plurality of grooves to engage and support a periphery of a wafer. A discharge structure, e.g., a discharging hole, promotes flow of a cleaning solution away from the grooves thereby more effectively drying the wafer by more readily discharging the cleaning solution by way of the discharging structure. The discharging structure reduces undesirable accumulation of the cleaning solution, such as deionized water, in the grooves during a wafer cleaning process. In some embodiments, a pump actively draws fluid away from the discharge structure.

This application claims the benefit of Korean Patent Application No. 10-2005-0006868, filed Jan. 25, 2005, the contents of which are hereby incorporated herein by reference in their entirety.

### BACKGROUND OF THE INVENTION

1. Field of the Invention

The present invention relates to a wafer guide and a semiconductor wafer drying apparatus using the same.

2. Description of Related Art

In general, a semiconductor device is manufactured by processing a semiconductor wafer through a series of semiconductor-manufacturing processes such as an oxidation process, a photolithography process, an etching process, a chemical vapor deposition (CVD) process, a diffusion process, and so on. During these semiconductor-manufacturing processes, a great quantity of impurities such as residues, fine particles, contaminants and so on may reside on the wafer surface. To remove these impurities, a cleaning process applied to the wafer surface is performed.

Furthermore, because the semiconductor device is highly integrated and detailed in patterns applied thereto, the cleaning process of the semiconductor wafer becomes a more important aspect of the semiconductor manufacturing processes.

In the cleaning process, a wet cleaning process generally includes a chemical solution cleaning step, a water cleaning step, and a drying step. The chemical solution cleaning step cleans the semiconductor wafer using a chemical solution. The water cleaning step cleans the semiconductor wafer, previously cleaned by the chemical solution, using a cleaning solution such as deionized water (DIW). The drying step dries the semiconductor wafer after being cleaned in the water cleaning step. In particular, when the semiconductor wafer is cleaned by the cleaning solution such as the deionized water and so on, it is important to dry thoroughly the wafer to prevent device failures as can occur due to water marks, e.g., DIW residue, remaining on the wafer surface subsequent to the water cleaning step.

Recently, a dry method utilizing a Marangoni effect has been used. The Marangoni dry method dries the wafer under a theory that liquid flows from a low surface tension region to a high surface tension region when two different surface tension regions exist in one liquid region. That is, isopropyl alcohol (IPA) vapor having a surface tension relatively smaller than that of the cleaning solution, e.g., DIW, is applied on the wafer surface to remove the cleaning solution from the wafer surface.

In particular, a minor amount of alcohol, e.g., 1/30˜ 1/50 in comparison with an IPA vapor drying apparatus, is used and N2 gas is used as a carrier gas to induce the Marangoni effect. It is possible to prevent carbon contamination, which may be generated in a device denser than 256 MDRAM in design rule, and to prevent photoresist from being affected.

However, a plurality of wafers to be dried by the method are supported by a wafer guide at its periphery, and then the water cleaning and drying processes are performed.

Therefore, the wafers as supported by the wafer guide are submerged in the cleaning solution, e.g., in a cleaning bath. When drying the wafers primarily cleaned by the cleaning solution, however, the wafer guide supporting the wafers on a surface of the cleaning solution, is exposed.

In this process, a method of exposing the wafers on the surface of the cleaning solution is classified into a method of lifting up the wafer guide using a lifter, and a method of draining the cleaning water from the cleaning bath to expose the wafers.

Since the plurality of wafers exposed on the surface of the cleaning solution through the noted methods are supported in a groove formed at the wafer guide in an upright manner and stacked thereon, the cleaning solution formed on the wafer surface flows downward by its own weight and passes through a drain mounted on the cleaning bath. Simultaneously, the wafers are dried by IPA vapor and nitrogen gas injected onto the wafer.

However, because the cleaning solution is not yet fully drained and can remain in the grooves, i.e., grooves supporting the wafers at the wafer periphery, water marks can form on the periphery of the wafer and cause a malfunction of the resulting semiconductor device.

Recently, to address such problems, Japanese Patent Laid-open Publication No. H10-270410 discloses that edges of the wafer are placed in contact with inner surfaces of the grooves, i.e., V-tapered portion, other than the bottom surface of the grooves. This causes the cleaning solution, such as DIW which may exist in the groove, to avoid direct contact with the wafer surface and makes the cleaning solution flow down the groove through the tapered parts, thereby preventing water marks from occurring on the wafer surface.

However, the cleaning solution still remains in the groove, not having been fully drained. Therefore, to more fully drain the cleaning solution remaining in the groove, a separate draining apparatus or a manual operation of an operator has been employed.

Accordingly, a need still exists for improving the methods of drying wafers and providing an improved wafer drying apparatus.

### SUMMARY

According to certain aspects of the present invention, a wafer guide and a semiconductor wafer drying apparatus using the same prevents water mark formation on a semiconductor wafer surface and more readily dries the wafer surface by way of a fluid discharge structure associated with the wafer support structure. The fluid discharge structure may assume a variety of shapes including, but not limited to, shapes increasing in size along a fluid discharge direction. In some embodiments, fluid may flow out the discharge structure. In other embodiments, fluid may be actively drawn through the discharge structure.

### BRIEF DESCRIPTION OF THE DRAWINGS

The foregoing and other objects, features and advantages of the invention will be apparent from the more particular description of a preferred embodiment of the invention, as illustrated in the accompanying drawing. The drawing is not necessarily to scale, emphasis instead being placed upon illustrating the principles of the invention.

FIG. 1A is a perspective view of a wafer guide in accordance with an embodiment of the present invention.

FIG. B is a cross-sectional view taken along line I-I′ shown in FIG. 1A.

FIG. 2 is a partial cross-sectional view taken along line II-II′ shown in FIG. 1A.

FIG. 3 is a partial cross-sectional view illustrating another embodiment of the discharging hole shown in FIG. 2.

FIG. 4 is a partial cross-sectional view illustrating still another embodiment of the discharging hole shown in FIG. 2.

FIG. 5 is a partial cross-sectional view further illustrating a discharging hole as shown in FIG. 2.

FIG. 6 is a partial cross-sectional view illustrating another embodiment of the groove shown in FIG. 2.

FIG. 7 is a partial cross-sectional view illustrating still another embodiment of the groove shown in FIG. 2.

FIG. 8 is a schematic cross-sectional view illustrating an embodiment of a semiconductor wafer drying apparatus in accordance with the present invention.

FIG. 9 is a partial cross-sectional view further illustrating a discharging hole as shown in FIG. 8.

FIG. 10 is a schematic cross-sectional view illustrating another embodiment of a semiconductor wafer drying apparatus in accordance with the present invention.

FIG. 11 is a partial cross-sectional view further illustrating a discharging hole as shown in FIG. 10.

### DETAILED DESCRIPTION

The present invention will now be described more fully hereinafter with reference to the accompanying drawings, in which exemplary embodiments of the invention are shown.

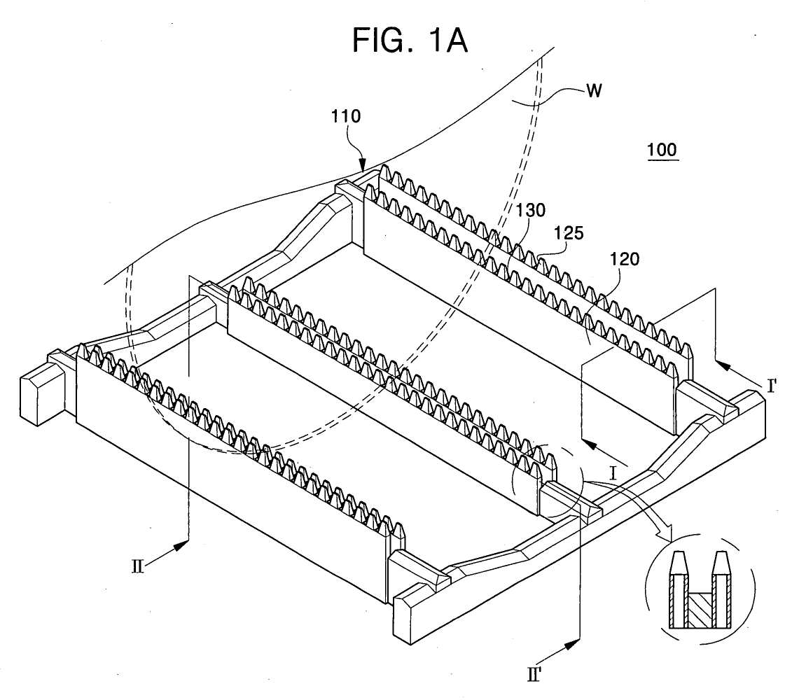

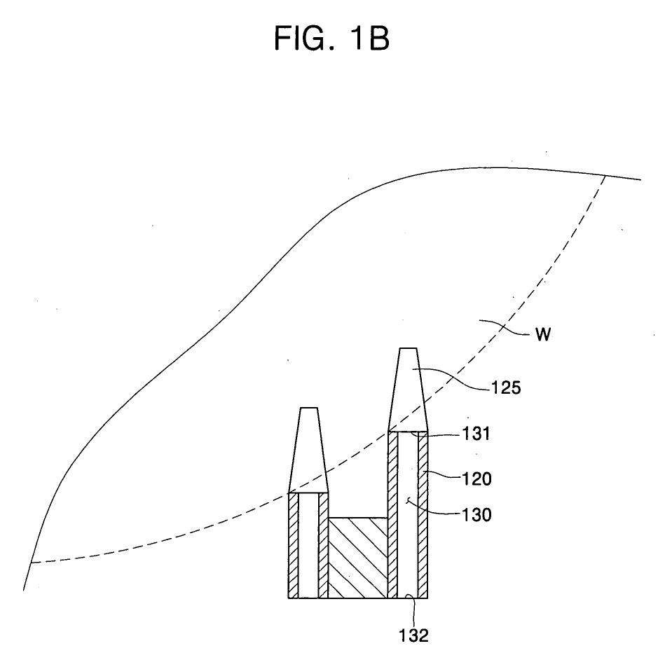

First, a wafer guide for a wafer drying apparatus in accordance with some embodiments of the present invention will be described in conjunction with FIGS. 1A to 7.

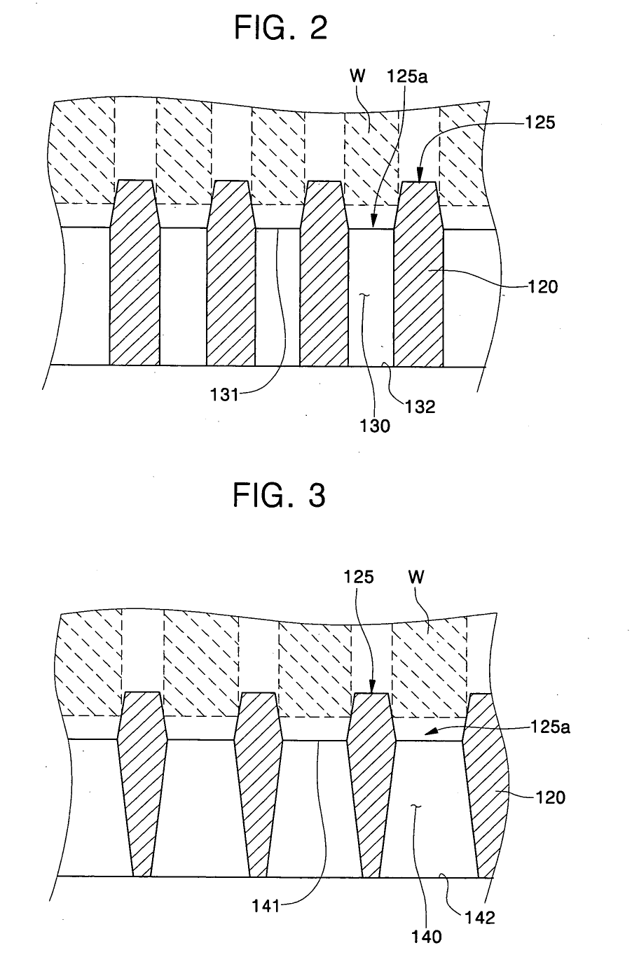

Referring to FIGS. 1A and 1B, the wafer guide 100 in accordance with some embodiments of the present invention includes a body 110 having three supporters 120 for supporting a wafer W at its periphery. A plurality of projections 125, formed on the supporters 120, establish grooves 125a (FIGS. 2-4) therebetween. A center one of supporters 120 presents projections 125 of similar height (FIG. 1A) to support the lower-most portion of the wafer W periphery while the outer two supporters 120 present projections 125 of differing height (e.g., as shown in FIG. 1B) to accommodate the curvature of the wafer W. Grooves 125a receive the periphery of the wafer W when inserted therein and thereby support wafer W in an upright orientation as illustrated in FIG. 1A. In this particular arrangement, the grooves 125a are formed between the projections 125. As will be appreciated, however, a variety of arrangements may be used to establish the grooves 125a. However, the groove 125a is preferably formed between the projections 125 to support the periphery of the wafer W.

FIG. 2 shows an exemplary embodiment of an inner shape of the grooves 125a between the projections 125. Preferably, inner-facing surfaces of the grooves 125a slope inward toward a discharging direction of a cleaning solution. As shown in FIG. 2, this allows substantially only the surface edges of the wafer W to contact with the inner-facing sloped surfaces of the grooves 125a in support of wafer W thereat. That is, it is preferred that the sloped surfaces of the grooves 125a are formed in a V-shape. The groove 125a has discharge structure therebelow, such as a discharging hole 130, for discharging the cleaning solution at an outlet port 132.

As shown in FIG. 3, however, the discharge structure may be a discharging hole 140 in fluid communication with an outlet port 142 to more readily discharge the cleaning solution such as DIW or impurities such as dusts introduced from an inlet port 141. More particularly, the discharging hole 140 as formed below the groove 125a tapers outward or expands in width toward the outlet port 142 and thereby more smoothly discharges the impurities such as dusts in the cleaning solution.

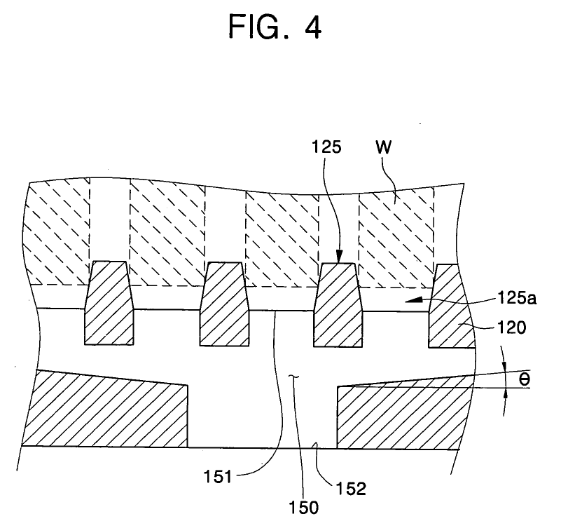

In addition, FIG. 4 shows another embodiment of inner surfaces of the groove 125a between the projections 125. Here the groove 125a is formed in Y shape. In other words, the Y shape is formed by a vertical surface connected downwardly and in contact the surface supporting the edge of the wafer W. Furthermore, the arrangement of FIG. 4 couples multiple grooves 125a with a single discharge structure.

Thus, FIGS. 2 and 3 show the inlet ports 131 and 141 and the outlet ports 132 and 142 of the discharging holes 130 and 140, respectively, in one-to-one fluid communication with each other. On the other hand, FIG. 4 shows as a discharge structure a discharging hole 150 having a plurality of inlet ports 151 and one outlet port 152 in collective fluid communication with the inlet ports 151. The outlet port is formed at a lower part of the corresponding supporter 120 for discharge of fluid therefrom. As may be appreciated, the outlet port 152 desirably is of size larger than that of the individual inlet ports 151.

In addition, preferably, an upward-facing surface of discharging hole 151 slopes downward at angle θ from the inlet ports 151 toward the outlet port 152 to smoothly discharge the cleaning solution toward and into the outlet port 152.

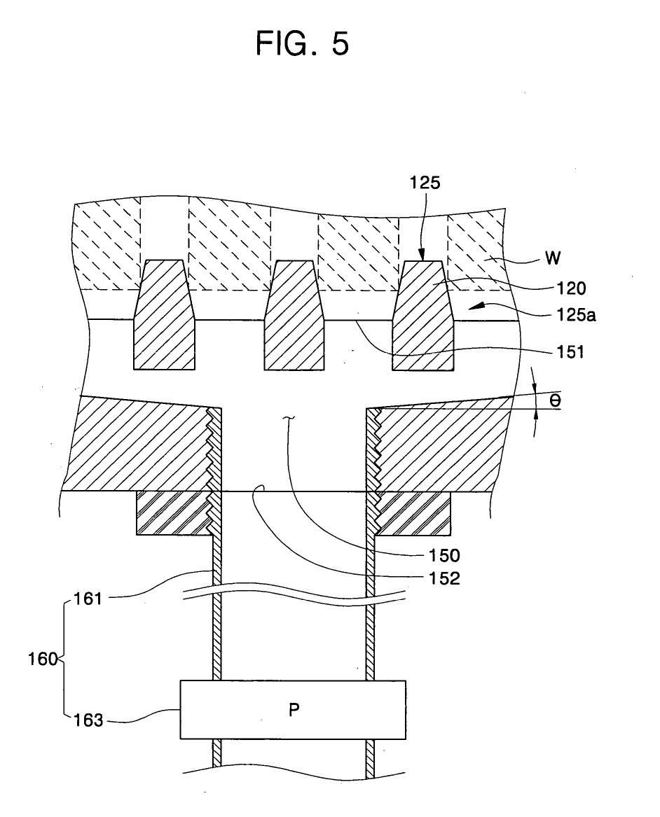

Referring to FIG. 5, drain 160 is additionally installed at the outlet port 152 of the discharging hole 150. The drain 160 includes a drain tube 161 threadably engaged with or in some fashion hermetically inserted into the outlet port 152. At the other end of the drain tube 161 a pump 163 connects to the drain tube 161 to actively evacuate the inner space of the discharging hole 150, e.g., draw fluid therefrom.

While FIG. 5 shows one outlet port 152 coupled to tube 161, it will be understood that it is possible, e.g., as applied to other embodiments of the present invention, to connect the drain tube 161 collectively to the plurality of outlet ports 132 and 142 and drive the pump 163 to forcibly discharge the inner spaces of the discharging holes 130 and 140, respectively. Thus, various embodiments of the present invention may use a pump, e.g., the pump 163, to actively draw fluid away from a wafer W.

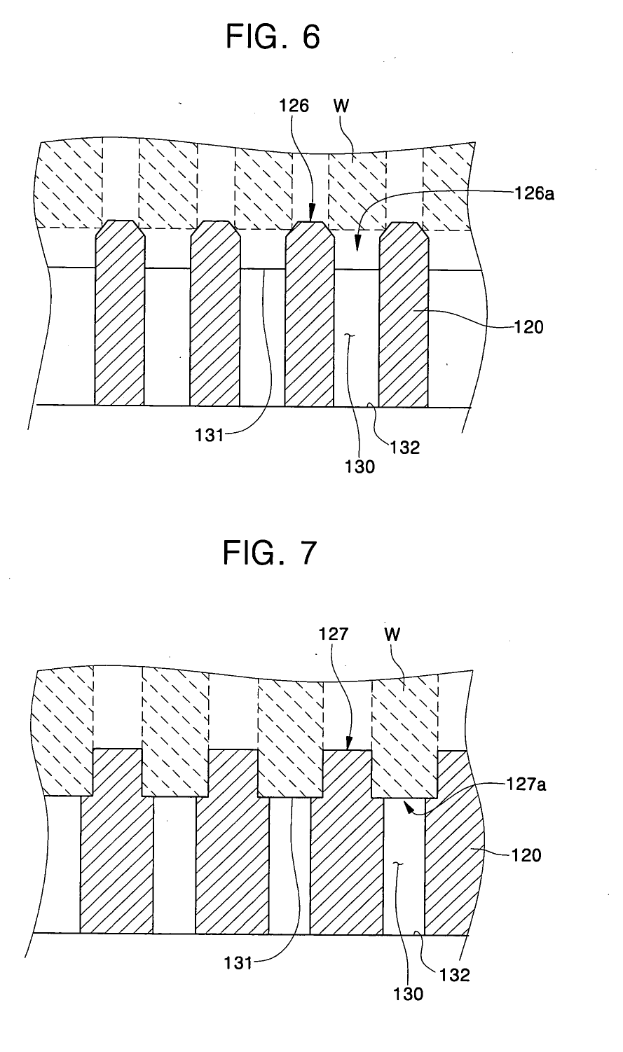

Referring to FIGS. 6 and 7, further alternative forms of projections, grooves, and discharge structures are shown. In FIGS. 6 and 7 discharging holes 130 are formed at grooves 126a (FIG. 6) or 127a (FIG. 7) to pass fluid therethrough to a lower portion of the associated supporter 120. The inner surfaces of grooves 126a may have sloped Y-shaped or V-shaped structure for contacting substantially only the surface edge of wafer W in support thereof. The inner surfaces of grooves 127a, however, have a rectangular shape allowing the periphery of the wafer W to be inserted and supported therein. In this particular arrangement, portions of the wafer W surface contact projections 127. The respective holes 130 formed on the associated supporter 120 have inlet ports 131 formed at the grooves 126a (FIG. 6) or 127a (FIG. 7). Outlet ports 132 are formed at a lower part of the associated supporter 120 to pass fluid from the associated supporter 120, e.g., as taken from the associated inlet ports 131. While the discharging holes 130 have the same or similar size and shape in relation to the inlet ports 131, it will be understood that a variety of shapes, e.g., other than the particular cylindrical shape shown, may be formed. For example, a polygonal-shaped hole such as a rectangular hole may be formed. Furthermore, various discharge structures may include increasingly wider dimensions in a fluid discharge direction, e.g., tapering outward in the direction of fluid discharge, for improved fluid and debris discharge therethrough.

Thus, it will be understood that a variety of groove-type structures may be formed to support a plurality of wafers W each in a generally upright orientation with associated discharge structures according to a variety of architectures to allow or encourage fluid discharge away from the wafers W, e.g., discharge holes in such proximity to associated supporting grooves so as to facilitate movement or drainage of fluid away from the points of contact with the wafers W. Further, in such variety of embodiments, it will be understood that fluid may be actively moved away from the wafers W, e.g., by fluidly coupling one or more pumps to the discharge structures.

Hereinafter, operation and effect of an exemplary embodiment of a wafer guide for a wafer drying apparatus of the present invention will be described. From this description, it will be understood that such operation and effect may be applied to a variety of embodiments of the present invention.

Referring to FIGS. 1A, 1B and 2, a plurality of wafers W are stacked on a wafer guide 100 in an upright manner. In this process, the wafer guide 100 has grooves 125a, in which each wafer is inserted and supported at its periphery, and in this state, a cleaning process is performed.

When the wafer guide 100 is applied to a semiconductor wafer drying apparatus for injecting and mixing a cleaning solution such as DIW and a mixed gas (for example, IPA vapor and nitrogen) to dry the plurality of wafers W, the plurality of wafers W stacked on the wafer guide 100 are primarily cleaned by the cleaning solution, and then dried by the mixed gas. A minor amount of cleaning solution, however, can remain in the grooves 125a.

In addition, the remaining cleaning solution may not be well dried or may be imperfectly discharged despite pressurized injection of the mixed gas over the wafer W. That is, the solution may be spread out or splashed across an inner surface of the groove 125a undesirably remaining in contact with the wafer W supported thereby.

In accordance with embodiments of the present invention, however, the remaining cleaning solution moves, e.g., into an inlet port 131 of a discharging hole 130 formed at the groove 125a, and flows for discharge toward an outlet port 132. Thus, the weight of the fluid and the injection pressure of the gas as forced into the groove 125a, e.g., between the projections 125 and the periphery of the wafer W, readily removes the cleaning solution out of contact with the wafer W. In other words, a discharge structure, e.g., discharge hole 130, associated with the supporting groove structure, e.g., groove 125a, facilitates desirable movement of fluid out of contact with the wafer W. In a process including application of pressurized gas, the discharge structure, e.g., a discharge hole 130, in association with a support structure, e.g., a groove 125a, encourages movement of the pressurized gas past and through the support structure and thereby promotes movement of fluid away from the wafer W as supported thereat.

The discharge structure, e.g., discharging hole 130 including the inlet ports 131 and the outlet ports 132 formed on the supporter 120, desirably includes hollow of size sufficient to readily introduce and discharge the cleaning solution.

In addition, e.g., in reference to FIG. 2, to more readily discharge the cleaning solution remaining in the supporting structure, e.g., in groove 125a, it is desirable to prevent discharging structure blockage, e.g., due to formation of a liquid film by the cleaning solution in the discharging hole 130. For example, is desirable to form the discharging hole 130 with a size larger than the inlet port 131, e.g., tapering outward toward the outlet port 132. Further, it is also possible by such tapering to readily discharge impurities when a minor amount of impurities, such as dusts contained in the cleaning solution, are to be discharged through the discharging hole 130.

Next, a cleaning solution discharging process through the outlet ports 132 and 142 of the discharging holes 130 and 140 will be described. While FIGS. 2 and 3 show the discharging holes 130 and 140 including the inlet ports 131 or 141 and the outlet ports 132 or 142 in communication with each other respectively, FIG. 4 shows that the cleaning solution introduced from the inlet ports 151 formed in the grooves 125a is discharged at one discharging port 152. That is, the minor amount of cleaning solution introduced from the plurality of inlet ports 151 formed in the grooves 125a flows toward the outlet port 152 as formed at a lower portion of the supporter 120. According to this particular embodiment, the discharging hole 150 has an inclined surface, e.g., at angle θ, to guide the cleaning solution from the inlet port 151 to the outlet port 152. Also, the outlet port 152 desirably has a size larger than that of the inlet port 151 whereby the cleaning solution readily flows by its weight and under of the injection pressure of the mixed gas for discharged therethrough.

Referring to FIG. 5, a drain tube 161 having a pump 163 may be mounted at the outlet port 152 to forcedly discharge the cleaning solution remaining in the groove 125a.

Meanwhile, an inner shape of the groove 125a for supporting the periphery of the wafer W may be variously formed. For example, the grooves 125a shown in FIGS. 2 and 3 have a V-shaped inner surface to support edges of the wafer W. Referring to FIG. 6, the groove 126a has inclined inner surfaces such that the edges of the wafer W are in contact with the inclined surfaces of a Y-shape. As a result, a minor amount of cleaning solution formed at the periphery of the wafer W and the cleaning solution remaining in the groove 126a can be discharged together through the discharging hole 130. Therefore, the cleaning solution remaining at the periphery of the wafer W flows along the inclined surface of the groove 126a by its weight to be gathered in the groove 126a, and then to be discharged to the outlet port 132 through the inlet port 131. Referring to FIG. 7, the groove 127a between the projections 127 has a right-angled surface to allow the periphery of the wafer to be inserted and supported therein, and the cleaning solution is discharged through the discharging hole 130.

In addition, the drain tube 161 may be connected to the respective outlet ports 132 and 142 as shown in FIGS. 2 and 3 or may be connected to the one outlet port 152 as shown in FIG. 4 to pump the cleaning solution by driving the pump 163 to forcedly discharge the cleaning solution remaining in the groove 125a, 126a and 127a.

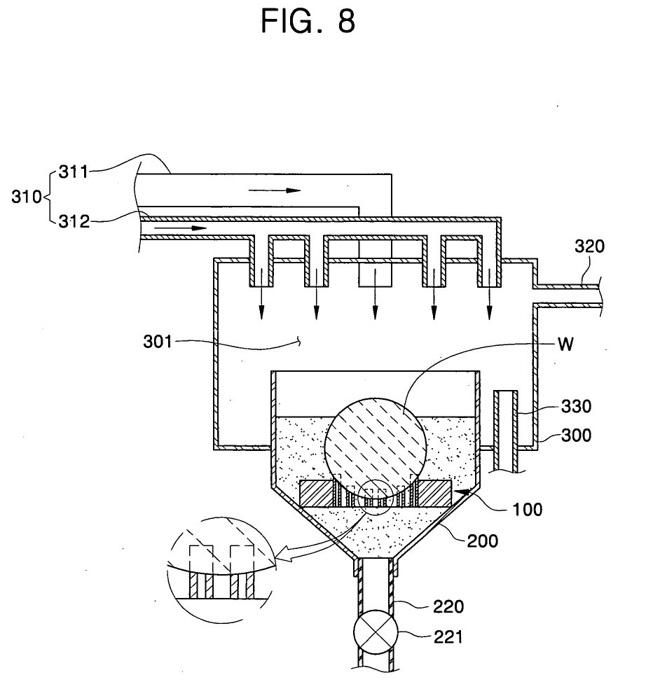

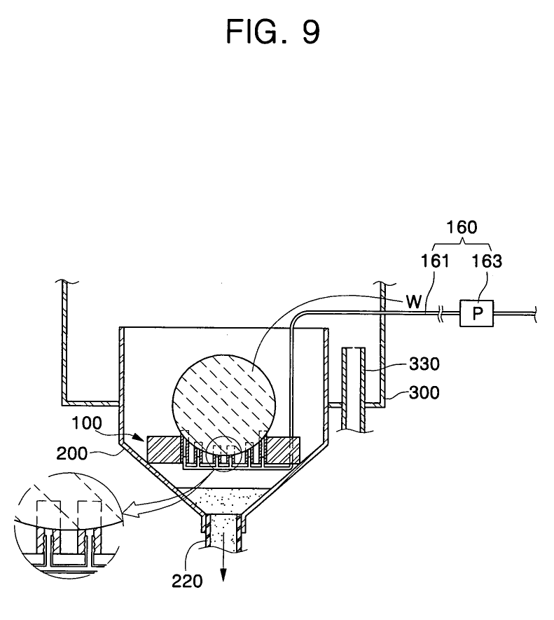

Hereinafter, an embodiment of a semiconductor wafer drying apparatus, to which a wafer guide 100 in accordance with the present invention is adapted, will be described in conjunction with FIGS. 8 and 9.

Referring to FIG. 8, the semiconductor wafer drying apparatus according to certain embodiments of the present invention may include a cleaning bath 200 having an access to introduce a cleaning solution therein. In this particular embodiment, a wafer exposing structure may be provided as a cleaning solution discharging pipe 220 connected to a lower part of the cleaning bath 200 to discharge the cleaning solution therefrom. In addition, the cleaning solution discharging pipe 220 may include a valve 221.

The cleaning solution bath 200 includes a chamber 300 engaged therewith to form an enclosed space 301 over the cleaning bath 200. The chamber 300 includes a gas supply pipe 310 for injecting a mixed gas into space 301. Typically, the gas supply pipe 310 includes a first gas supply pipe 311 to inject IPA vapor, and a second gas supply pipe 312 to inject nitrogen gas. In this process, the space 310 is sufficient to apply the mixed gas onto the wafer W.

In addition, the cleaning bath 200 may include an overflow discharging pipe 330 installed at the chamber 300 to discharge overflowed cleaning solution when the cleaning solution overflows at an upper part of the cleaning bath. The chamber 300 may also include a gas discharging pipe 320 for discharging the mixed gas.

In this process, the wafer guide 100 as described above is disposed in the cleaning bath 200 whereat the cleaning solution resides.

As previously described but not specifically shown in FIG. 8, the wafer guide 100 includes a body 110, and three supporters 120 formed on the body 110. Each of the supporters 120 includes a plurality of projections 125 to from grooves 125a for supporting the periphery of the wafer W when inserted and supported in the grooves 125a at its periphery, and includes discharging holes 130 in association with the grooves 125a to pas fluid to a lower portion of the supporters 120. In this process, the grooves 125a between the projections 125 may have a variety of shapes, e.g., a rectangular inner shape such that the periphery of the wafer W is inserted therein or a V or Y-shape such that the edges of the wafer is in contact with sloped inner surfaces of the groove 125a to support the wafer W.

In FIG. 9, wafer guide 100 may include a drain 160, e.g., a drain tube 161 coupling a discharge structure associated with wafer support structures to a pump 163 whereby fluid remaining at a support structure, e.g., a groove 125a, is actively draw out through the discharge structure, e.g., discharge hole 130, and away from the wafer W.

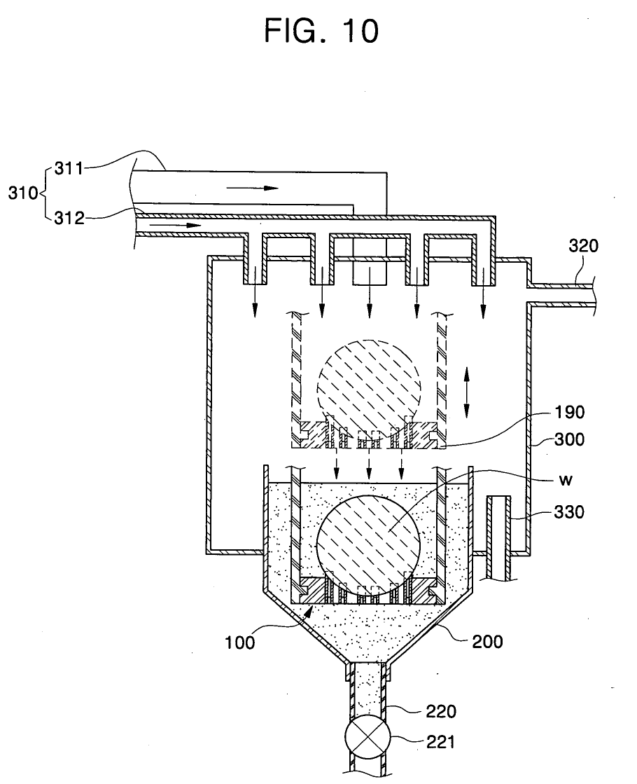

Referring to FIG. 10, inlet ports 141 of a discharging hole 140 formed in the grooves 125a, outlet ports 142 formed at a lower part of the supporter 120 to be in fluid communication with the inlet ports 141, and the discharging hole 140 may have a constant size or a size enlarged relative to the inlet ports 141, e.g., similar to that of the discharging hole 140 shown in FIG. 3.

In addition, as shown in FIGS. 2, 3, 5 and 6, the discharging hole 130 may include the inlet ports 131 and the outlet ports 132 which are individually formed and in fluid communication with each other, or as shown in FIG. 4, may include a plurality of inlet ports 151 and one outlet port 152 formed at a lower part of the supporter 120 to be in communication with the inlet ports 151. Of course, preferably, the outlet port 152 has a size larger than that of the inlet port 151.

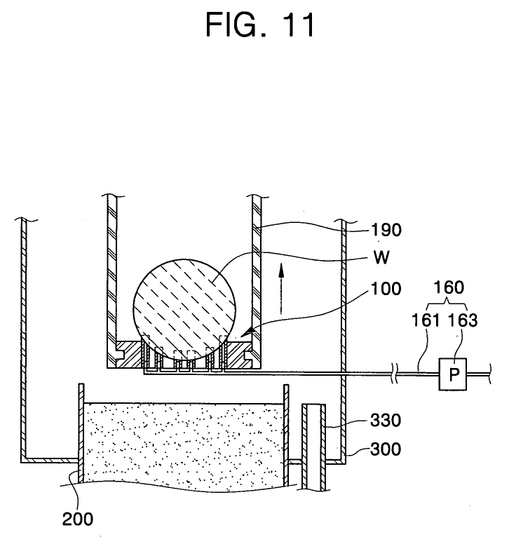

Referring to FIG. 11, drain 160 may be additionally connected to the discharging holes 130 formed at the wafer guide 100 to forcedly discharge the cleaning solution.

The drain 160 includes a drain tube 161 connected to the plurality of outlet ports 132 formed at the lower part of the supporter 120 through screws, and a pump 162 connected to the drain tube 161. The drain tube 161 is connected to the exterior of the chamber 300 through the overflow discharging pipe 330, and the pump 163 is connected to the drain tube 161 to forcibly discharge the cleaning solution in the discharging hole 130.

In this process, while the drain tube 161 is connected to the exterior through the above-mentioned embodiment, a through-hole (not shown) may be formed at the chamber 300 to be connected to the exterior. At this time, the through-hole is preferably sealed using a packing ring (not shown) to hermetically seal the interior of the chamber 300 relative to the exterior of the chamber 300.

Thus, a variety of the particular support structures and discharge structures may be used in application of embodiments of the present invention to a wafer drying apparatus.

Hereinafter, an operation of the semiconductor wafer drying apparatus in accordance with embodiments of the present invention will be described.

Referring to FIG. 8, the cleaning bath 200 contains a cleaning solution for cleaning surfaces of the wafers W, and the wafer guide 100 is disposed in the cleaning bath 200 to stack a plurality of wafer W in an upright manner.

In this state, the cleaning bath 200 is installed at a lower part of the chamber 300. At this time, the cleaning bath 200 has an inner space formed thereon and sealed from the exterior of the chamber 300. In addition, the wafer guide 100 and the plurality of wafers W are primarily cleaned together, e.g., submerged together in the cleaning solution.

When the cleaning solution in the cleaning bath 200 is thereafter discharged through the cleaning discharging pipe 220 as installed at a lower part of the cleaning bath 200, the wafers W are exposed in the chamber 300. To then dry the exposed surface of the wafers W, IPA vapor and nitrogen gas are injected onto the wafers W through the gas supply pipe 310. The injected gas makes the cleaning solution at the surface of the wafer W flow downward and thereby dries the exposed surface of the wafer W.

At this point, the cleaning solution remaining in the grooves 125a between the projections 125 supporting the periphery of the wafer W is introduced into the inlet ports 131 formed at the grooves 125a, and flows down the outlet ports 132 due to its weight and the gas injection pressure onto the wafer W. As a result, the remaining cleaning solution is discharged to the exterior of the associated supporter 120.

As described above, to more readily discharge the cleaning solution, e.g., as discharged to the outlet port 142, the discharge structure, e.g., discharging hole 140, may have a size larger than the corresponding inlet, e.g., inlet ports 141. This arrangement may prevent formation of a liquid film, e.g., in the discharging hole 140 and thereby more readily promote discharge of the cleaning solution, especially when the injection pressure of the mixed gas applied to the wafer W is low or when the cleaning solution is not well discharged by its weight only.

In addition, referring to FIG. 9, the drain 160 may be installed, e.g., at the outlet ports 131 formed at a lower part of the supporter 120, to forcibly discharge the cleaning solution, e.g., remaining in the grooves 125a, through the drain tube 161 by operation of the pump 163. As a result, it is possible to more fully remove any liquid film which may be formed, e.g., in the discharging hole 130 or more fully remove any remaining amount of cleaning solution, e.g., between the wafer W and the surfaces of the grooves 125a.

Next, after the wafers W are dry, the cleaning bath 200 is demounted from the chamber 300 and the wafer guide 100 is demounted from the cleaning bath 200, thereby performing the next process. In this process, when the drain 160 is installed at the wafer guide 100, the drain 160 should be separated from the wafer guide 100 after the wafers W are dry.

Hereinafter, another embodiment of the semiconductor wafer drying apparatus having a wafer guide in accordance with embodiments of the present invention will be described in conjunction with FIGS. 10 and 11.

Referring to FIG. 10, the semiconductor wafer drying apparatus having a wafer guide in accordance with embodiments the present invention has a similar configuration as the earlier-described embodiment, except for the following. Disposed in the cleaning bath 200, along with the cleaning solution, the wafer guide 100 resides and includes generally the aforementioned configuration. A guide lifter 190, e.g., installed at an upper part of the chamber 300, moves up and down as indicated in FIG. 10, e.g., by supplying power to the guide lifter 190 from outside chamber 300. In this process, the guide lifter 190 is the wafer exposing structure, e.g., operates to expose the wafers W following emersion in the cleaning solution.

The particular configuration of the wafer guide 100 of FIGS. 10 and 11 will not be further described as it may be provided in substantially similar form and operation as that of FIGS. 8 and 9.

Referring to FIG. 11, in cleaning and drying the surface of the wafer W, the cleaning bath 200 has the same configuration as the previous embodiment, except that the wafer guide 100 is lifted and exposed using the guide lifter 190. In other words, the wafer is exposed without discharging the cleaning solution from the cleaning bath 200.

Hereinafter, an operation of the semiconductor wafer drying apparatus will be described in conjunction with FIG. 11.

The guide lifter 190 receives power from the exterior to lift the wafer W and the wafer guide 100 as submerged in the cleaning solution into the chamber 300 and thereby expose the wafer W following emersion in the cleaning solution. At this time, IPA vapor and nitrogen gas are injected from the gas supply pipe 310 as installed at an upper part of the chamber 300 to dry the surface of the wafer W.

Then, the cleaning solution, e.g., remaining in the grooves 125a supporting the periphery of the wafers W, is flows into the discharge structures, e.g., flows into the inlet ports 131 as formed at the respective grooves 125a and discharges at outlet ports 132, due to its weight and gas injection pressure injected applied onto the wafer W.

To more readily discharge the cleaning solution, e.g., into the outlet ports 132, the discharging structure, e.g. discharging hole 130, may have an increasing size, e.g., increasing from the inlet ports 141 to the outlet ports 142. It is thereby possible to prevent a liquid film from forming in the discharge structure, e.g., forming in the discharging hole 140, and thereby more readily discharge the cleaning solution, especially when injection pressure of the mixed gas onto the wafer W is weak.

In addition, referring to FIG. 5, the drain 160 may be coupled in communication with the discharging structure, e.g., the discharging hole 130, to forcibly discharge the cleaning solution remaining in support structure, e.g., remaining in the grooves 125a.

After the wafer W is dry, the cleaning bath 200 is demounted from the chamber 300, the guide lifter 190 operates to lift the wafer guide 100, and then the wafer guide 100 is separated from the guide lifter 190 to perform the next process. In this process, when the drain 160 is installed at the wafer guide 100, the drain 160 may be separated from the wafer guide 100 after the wafer W is dry.

As may be appreciated, in the case of addition installation of the drain 160, when the wafer guide 100 is conveyed to the next process, e.g., through an automated conveyer (not shown), the drain tube 161 may have a length sufficient allow operation of the conveyer in the cleaning bath 200 and the chamber 300.

Therefore, as described in various embodiments herein, as the wafer guide is adapted to the semiconductor wafer drying apparatus, it is possible to stack the wafers on the wafer guide and effectively dry the wafers by removing the minor amount of cleaning solution during the cleaning and drying processes.

As can be seen from the foregoing, the wafer guide and the semiconductor wafer drying apparatus according to various embodiments of the present invention better dries the wafers by forming the discharging hole in association with, e.g., at, the wafer guide and thereby more readily discharges any cleaning solution remaining in the grooves supporting the periphery of the wafer, e.g., as when the plurality of wafers are stacked in an upright manner following exposure to the cleaning solution.

In accordance with embodiments of the present invention, therefore, it is possible to avoid or minimize formation of water marks at the wafer surface, avoid or minimize failures associated with such water marks, and thereby and increase overall productivity and quality of the resulting semiconductor product.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A wafer guide for a wafer drying apparatus comprising:
a body; and
a supporter formed on the body, the supporter having a plurality of grooves positioned to support the periphery of a wafer and having a discharge structure to carry cleaning solution away from the grooves.

2. The wafer guide according to claim 1, wherein the discharge structure includes a discharging hole to pass the cleaning solution downwardly therethrough.

3. The wafer guide according to claim 2, wherein the discharging hole widens along a cleaning solution discharging direction.

4. The wafer guide according to claim 2, wherein the discharging hole is connectable to a drain tube coupled a pump to forcibly draw cleaning solution from the groove.

5. The wafer guide according to claim 1, wherein the groove slopes inward along a discharging direction of the cleaning solution.

6. The wafer guide according to claim 1, wherein the groove has a rectangular shape.

7. A semiconductor wafer drying apparatus comprising:
a cleaning bath to hold a wafer cleaning solution;
a chamber to enclose the cleaning bath and to form a chamber space;
a gas supply pipe to introduce a mixed gas into the chamber space;
a gas discharging pipe to discharge the mixed gas from within the chamber; and
a wafer guide selectively positionable for immersion and displacement relative to the wafer cleaning solution and including a body to support at least one wafer, a supporter formed on the body and having a plurality of grooves to support the at least one wafer at its periphery, and a discharge structure to carry away residual wafer cleaning solution when remaining at the grooves subsequent to the wafer guide being displaced relative to the wafer cleaning solution.

8. The semiconductor wafer drying apparatus according to claim 7, further comprising a discharging pipe to selectively displace the wafer guide relative to the wafer cleaning solution, the discharge pipe being installed at a lower end of the cleaning bath to discharge the wafer cleaning solution from the cleaning bath and to thereby displace the wafer guide relative to the wafer cleaning solution.

9. The semiconductor wafer drying apparatus according to claim 7, further comprising a guide lifter connectable to the wafer guide to selectively move the wafer guide relative to the wafer cleaning solution when held in the cleaning bath and to thereby selectively immerse and displace the wafer guide relative to the wafer cleaning solution.

10. The semiconductor wafer drying apparatus according to claim 7, wherein the discharging hole widens along a wafer cleaning solution discharging direction.

11. The semiconductor wafer drying apparatus according to claim 7, wherein the discharging hole is connectable to a drain tube and a pump to forcibly draw the wafer cleaning solution from the groove.

12. The semiconductor wafer drying apparatus according to claim 7, wherein at least one of the plurality of grooves slopes inward along a wafer cleaning solution discharge direction.

13. The semiconductor wafer drying apparatus according to claim 7, wherein at least one of the plurality of grooves has a rectangular shape.

14. A wafer guide comprising:
a body supporting at least one wafer support structure; and
at least one fluid discharge structure associated with the at least one wafer support structure.

15. The wafer guide according to claim 14, wherein the wafer support structure comprises a groove formation to engage a wafer periphery.

16. The wafer guide according to claim 14, wherein the at least one fluid discharge structure comprises a discharging hole positioned to carry fluid downwardly and away from the associated at least one wafer support structure.

17. The wafer guide according to claim 16, wherein the discharging hole includes an inlet adjacent the at least one wafer support structure and an outlet positioned below the inlet whereby fluid when at the at least one wafer support structure flows by its weight into the inlet and toward the outlet.

18. The wafer guide according to claim 16 wherein the discharging hole increases in size along a fluid discharge direction.

19. The wafer guide according to claim 14, further comprising a pump connectable to the discharge structure to actively draw fluid away from the at least one wafer support structure.

20. The wafer guide according to claim 14, further comprising a plurality of wafer support structures and wherein the discharge structure comprises a plurality of inlets each fluidly coupled to an associated wafer support structure and a common outlet fluidly coupled to each of the inlets.

21. The wafer guide according to claim 20, further comprising a pump, the outlet being connectable to the pump the draw fluid from the plurality of wafer support structures.
